(19) United States
(12) Patent Application Publication
(10) Pub. No.: US 2018/0201341 A1
(43) Pub. Date: Jul. 19, 2018

(54) CHAIN

(71) Applicant: KMC Chain Industrial Co., Ltd., Tainan City (TW)

(72) Inventor: Daniel WU, Tainan City (TW)

(21) Appl. No.: 15/861,790

(22) Filed: Jan. 4, 2018

(30) Foreign Application Priority Data
Jan. 13, 2017 (TW) 106101166

(51) Int. Cl. B62M 9/08; F16H 9/24; F16G 13/06

(52) U.S. Cl. CPC B62M 9/08; F16H 7/06; F16G 13/06; F16H 9/24

(57) ABSTRACT

A chain includes an inner link unit. The inner link unit includes an inner chain plate, and an accompanying chain plate spaced apart from the inner chain plate. The inner chain plate has two spaced-apart end sections, and a connecting section interconnecting the end sections and having a first recess. The first recess has two first edges parallel to each other. The accompanying chain plate has a second recess that has two second edges parallel to each other. The first edges of the first recess and the second edges of the second recess extend in the same direction.

### CROSS-REFERENCE TO RELATED APPLICATION

This application claims priority of Taiwanese Patent Application No. 106101166, filed on Jan. 13, 2017.

### FIELD

The disclosure relates to a chain, and more particularly to a chain for use in a variable speed drivetrain.

### BACKGROUND

A transmission chain is an assembly of inner chain plates, outer chain plates, connecting rods and rollers, and is cooperatively used with sprockets. When the transmission chain is used in a variable speed drivetrain, it would be frequently moved from one sprocket to another. Therefore, auxiliary structures of the chain plates are needed for aiding the movement of the transmission chain among the sprockets.

Taiwanese Patent No. 1500555 discloses a conventional inner chain plate that has two opposite end sections, a connecting section connected between the end sections, and a recess formed in a side surface of the connecting section. The recess has two arc-shaped edges that are respectively proximate to the end sections. When a pair of the conventional inner chain plates cooperatively serve as an inner link unit of a transmission chain in such a manner that the recesses thereof face toward each other, a space formed between the conventional inner chain plates has a relatively large width so as to facilitate the movement of the transmission chain form one sprocket to another. However, in the forming process of the conventional inner chain plate, separation of the conventional inner chain plate from a forming die is relatively difficult due to the presence of the arc-shaped edges of the recess.

In addition, Taiwanese Utility Model Patent No. M338930 discloses a conventional transmission chain for a variable speed bicycle. The conventional transmission chain includes a plurality of inner link units each including two spaced-apart inner chain plates, and a plurality of outer link units each including two spaced-apart outer chain plates. The inner and outer link units are interconnected in an alternating arrangement. Specifically, each of the inner chain plates of the inner link units is formed with an inclined groove, and each of the outer chain plates of the outer link units is formed with an inclined groove as well. The inclined grooves of the inner chain plates of each of the inner link units are oblique to each other. Likewise, the inclined grooves of the outer chain plates of each of the outer link units are oblique to each other. Although the inclined grooves serve to increase the width of the space defined between the inner chain plates of each of the inner link units, the width is insufficient since the inclined grooves of the inner chain plates of each of the inner link units are oblique to each other.

Taiwanese Utility Model Patent No. M287192 discloses a conventional outer chain plate that has a protrusion. When a pair of the conventional outer chain plates cooperatively serve as an outer link unit of a transmission chain in such a manner that the protrusions thereof protrude away from each other, the protrusions thereof serve to diminish collision between the transmission chain and a set of sprockets. However, the width of a space defined in an inner link unit of the transmission chain is still relatively small.

### SUMMARY

Therefore, an object of the disclosure is to provide a chain that can alleviate at least one of the drawbacks of the prior arts.

According to the disclosure, the chain includes at least one inner link unit. The inner link unit includes an inner chain plate, an accompanying chain plate that is spaced apart from the inner chain plate, and an engaging space that is defined between the inner chain plate and the accompanying chain plate. The inner chain plate has two end sections that are spaced apart from each other along a central line, and a connecting section that interconnects the end sections and that has a first recess recessed away from the accompanying chain plate. Each of the end sections has a rod hole. The first recess has two first edges that are parallel to each other. The accompanying chain plate of the at least one inner link unit has a second recess that is recessed away from the inner chain plate. The second recess has two second edges that are parallel to each other and that are spaced apart from each other. The first edges of the first recess and the second edges of the second recess extend in the same direction.

### BRIEF DESCRIPTION OF THE DRAWINGS

Other features and advantages of the disclosure will become apparent in the following detailed description of the embodiments with reference to the accompanying drawings, of which:

FIG. 1 is a fragmentary top view illustrating a first embodiment of the chain according to the disclosure;

FIG. 2 is a fragmentary side view of the chain with a sprocket assembly;

FIG. 3 is a perspective view illustrating an inner chain plate of an inner link unit of the first embodiment;

FIG. 4 is a side view illustrating the inner chain plate of the first embodiment;

FIG. 5 is a sectional top view illustrating the inner chain plate and an accompanying chain plate of the first embodiment;

FIG. 6 is a sectional view taken along line 6-6 in FIG. 4;

FIG. 7 is a fragmentary top view illustrating a second embodiment of the chain according to the disclosure;

FIG. 8 is a sectional top view illustrating an inner chain plate and an accompanying chain plate of the second embodiment;

FIG. 9 is a side view illustrating an inner chain plate of a third embodiment of the chain according to the disclosure;

FIG. 10 is schematic sectional view illustrating an inner chain plate and an accompanying chain plate of the second embodiment used with a sprocket;

FIG. 11 is a side view illustrating an inner chain plate of a fourth embodiment of the chain according to the disclosure; and

FIG. 12 is a side view illustrating an inner chain plate of a fifth embodiment of the chain according to the disclosure.

### DETAILED DESCRIPTION

Before the disclosure is described in greater detail, it should be noted that where considered appropriate, reference numerals or terminal portions of reference numerals have been repeated among the figures to indicate corresponding or analogous elements, which may optionally have similar characteristics.

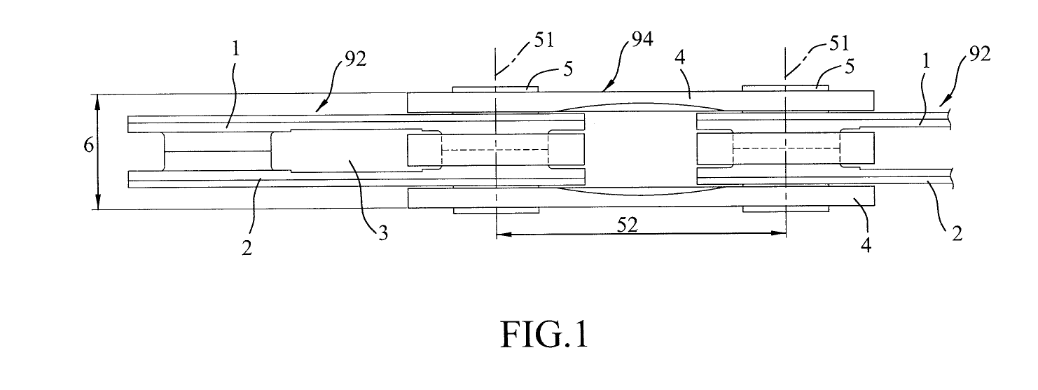

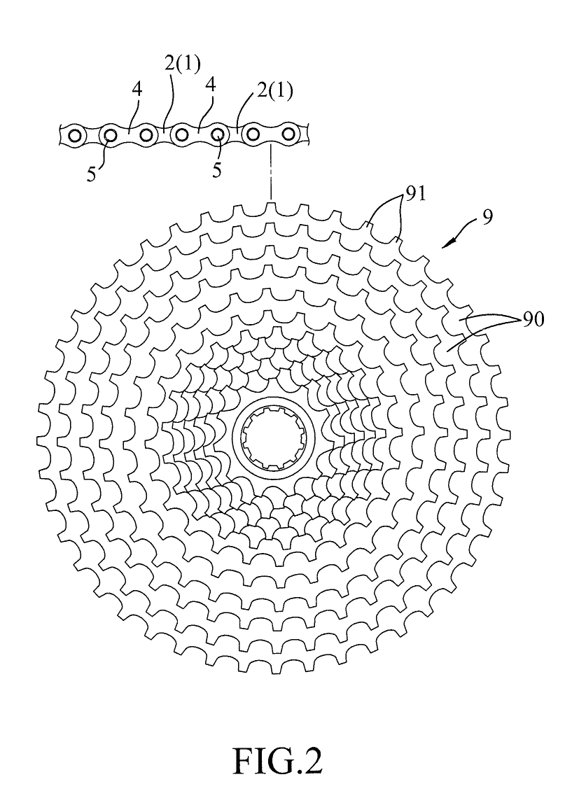

Referring to FIGS. 1 and 2, the first embodiment of the chain according to the disclosure is cooperatively used with a sprocket assembly 9 (see FIG. 2). The sprocket assembly 9 includes twelve coaxially-arranged sprockets 90, each of which has a plurality of teeth 91.

The chain includes a plurality of inner link units 92 that are spaced apart from each other. Each of the inner link units 92 includes an inner chain plate 1, an accompanying chain plate 2 that is spaced apart from the inner chain plate 1, and an engaging space 3 that is defined between the inner chain plate 1 and the accompanying chain plate 2. The chain further includes a plurality of outer link units 94 each of which is connected between two adjacent ones of the inner link units 92, and a plurality of connecting rods 5 each of which has a central axis 51, and interconnects one of the inner link units 92 and a corresponding one of the outer link units 94. Each of the outer link units 94 includes two spaced-apart outer chain plates 4 that are respectively disposed at opposite lateral sides of the corresponding inner link unit 92. The central axes 51 of two adjacent ones of the connecting rods 5 are spaced apart from each other by a link distance 52. The ratio of the link distance 52 to the width 6 of the outer link units 94 is 2.39±0.12. The link distance 52 corresponds to the chordal pitch of each of the sprockets 90.

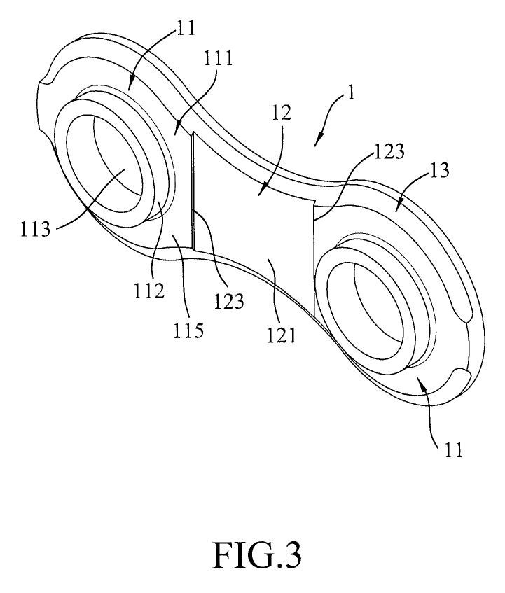

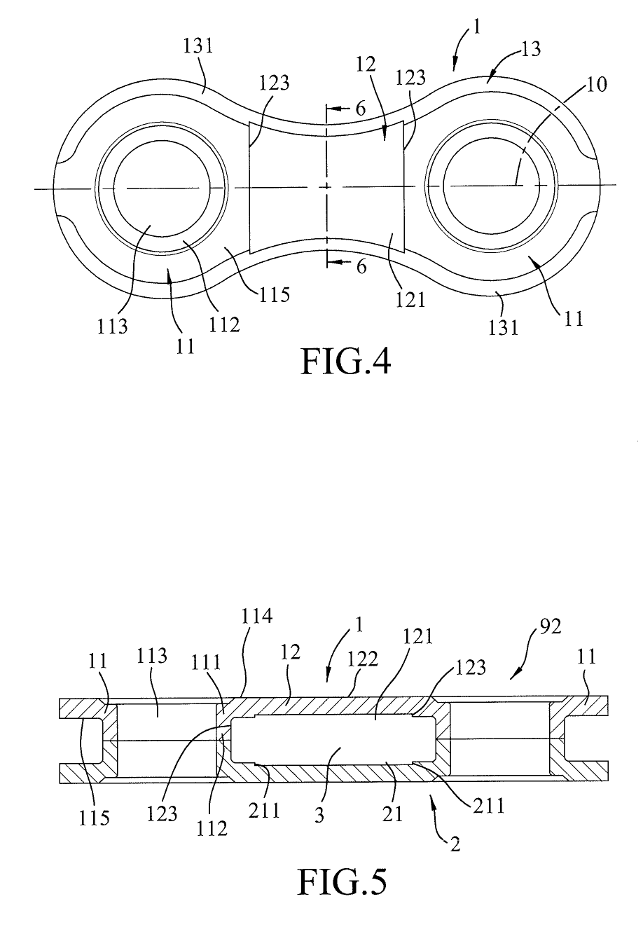

Referring to FIGS. 3 to 5, in this embodiment, the inner chain plate 1 of each of the inner link units 92 has two end sections 11 that are spaced apart from each other along a central line 10 (see FIG. 4), a connecting section 12 that interconnects the end sections 11, and a guide section 13 that surrounds the end sections 11 and the connecting section 12.

For the sake of brevity, only one of the inner link units 92 is described in the following paragraphs.

Each of the end sections 11 of the inner chain plate 1 has a base wall 111 that is integrally connected to the connecting section 12, a protrusion 112 that protrudes from the base wall 111 toward the accompanying chain plate 2, and a rod hole 113 that is formed through the base wall 111 and the protrusion 112. The base wall has an outer annular surface 114 that faces away from the accompanying chain plate 2, and an inner annular surface 115 that faces toward the accompanying chain plate 2.

The connecting section 12 has a first recess 121 that is recessed away from the accompanying chain plate 2, and an outer connecting surface 122 that faces away from the accompanying chain plate 2. The first recess 121 has two first edges 123 that are spaced apart from each other and that are respectively proximate to the end sections 11. In this embodiment, the first edges 123 extend across the central line 10, are perpendicular to the central line 10, and are parallel to each other. In this embodiment, the outer connecting surface 122 of the connecting section 12 is connected to the outer annular surfaces 114 of the end sections 11, and is flush with the outer annular surfaces 114. The central line 10 substantially passes through the center of the rod hole 113 of each of the end sections 11.

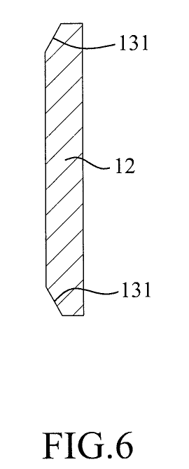

Referring to FIGS. 3, 5 and 6, the guide section 13 has two inclined guide surfaces 131 that are respectively located at two opposite sides of the central line 10 and that face toward the accompanying chain plate 2. Each of the inclined guide surfaces 131 extends along a periphery of the inner chain plate 1 and extends over the connecting section 12. Each of the inclined guide surfaces 131 is inclined away from the accompanying chain plate 2 in a direction away from the central line 10.

The accompanying chain plate 2 of the inner link unit 92 may be structurally identical to the inner chain plate 1. Preferably, the accompanying chain plate 2 has a second recess 21 that is recessed away from the inner chain plate 1. In other words, the inner link unit 92 has first and second recesses 121, 21 that face toward each other. The second recess 21 has two second edges 211 that respectively correspond in position to the first edges 123 of the first recess 121 of the inner chain plate 1 and that are parallel to the first edges 123 (i.e., the first recess 121 and the second recess 21 are parallel to each other). A distance between the second edges 211 is the same as that between the first edges 123.

Referring to FIGS. 2, 4 and 5, since the first recess 121 of the inner chain plate 1 is recessed away from the accompanying chain plate 2 and since the second recess 21 of the accompanying chain plate 2 is recessed away from the inner chain plate 1, the engaging space 3 defined between the inner chain plate 1 and the accompanying chain plate 2 has a relatively large width. It should be noted that since the first recess 121 and the second recess 21 are parallel to each other, the width (or an opening) of the engaging space 3 is sufficiently increased so as to facilitate entrance of a corresponding one of the teeth 91 of the sprockets 90 into the engaging space 3 during the movement of the chain from one of the sprockets 90 to another.

In addition, the inclined guide surfaces 131 of the guide section 13 serve to guide the entrance of a corresponding one of the teeth 91 of the sprockets 90 into the engaging space 3, so the chain is smoothly movable among the sprockets 90. It should be noted that since the first edges 123 of the first recess 121 of the inner chain plate 1 are parallel to each other, in a forming process, the inner chain plate 1 can be easily separated from a forming die.

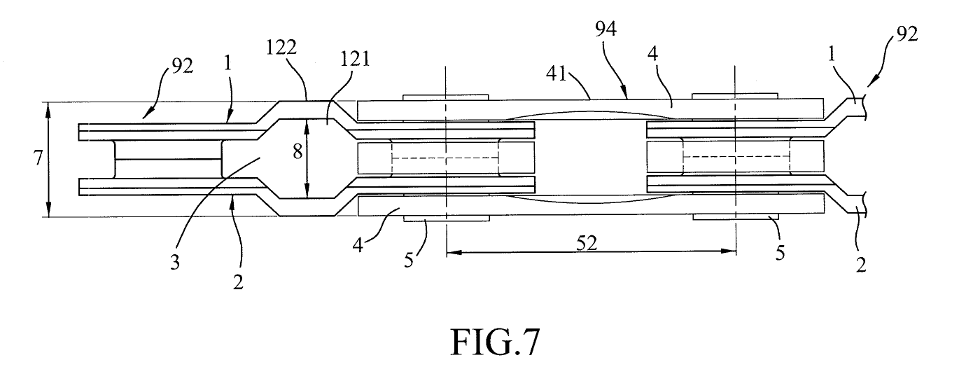

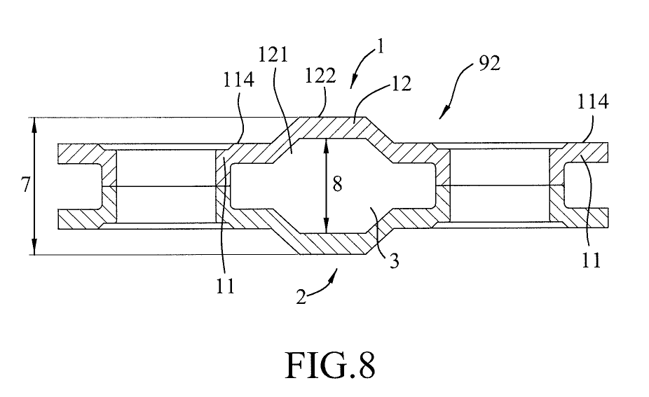

Referring to FIGS. 7 and 8, the second embodiment of the chain according to the disclosure is different from the first embodiment in the inner link units 92. The outer connecting surface 122 of the connecting section 12 of the inner chain plate 1 is not flush with the outer annular surfaces 114 of the end sections 11, and is farther from the accompanying chain plate 2 than the outer annular surfaces 114.

In more detail, the connecting section 12 of the inner chain plate 1 is misaligned from the end sections 11, and is farther from the accompanying chain plate 2 than the end sections 11, so that the connecting section 12 cooperates with the end sections 11 to form the first recess 121. The outer connecting surface 122 of the connecting section 12 is flush with an outer surface 41 of a corresponding one of the outer chain plates 4. The accompanying chain plate 2 is structurally identical to the inner chain plate 1. The ratio of the link distance 52 to a maximum width 7 of the inner link unit 92 is 2.39±0.12. The ratio of the link distance 52 to a maximum width 8 of the engaging space 3 defined between the inner chain plate 1 and the accompanying chain plate 2 is 5.5±0.12. By such, the engaging space 3 has a relatively large width, and the chain is smoothly movable among the sprockets 90 (see FIG. 2). In a modification, the maximum width 8 of the engaging space 3 is equal to the width of a space defined between the outer chain plates 4 of the outer link unit 94.

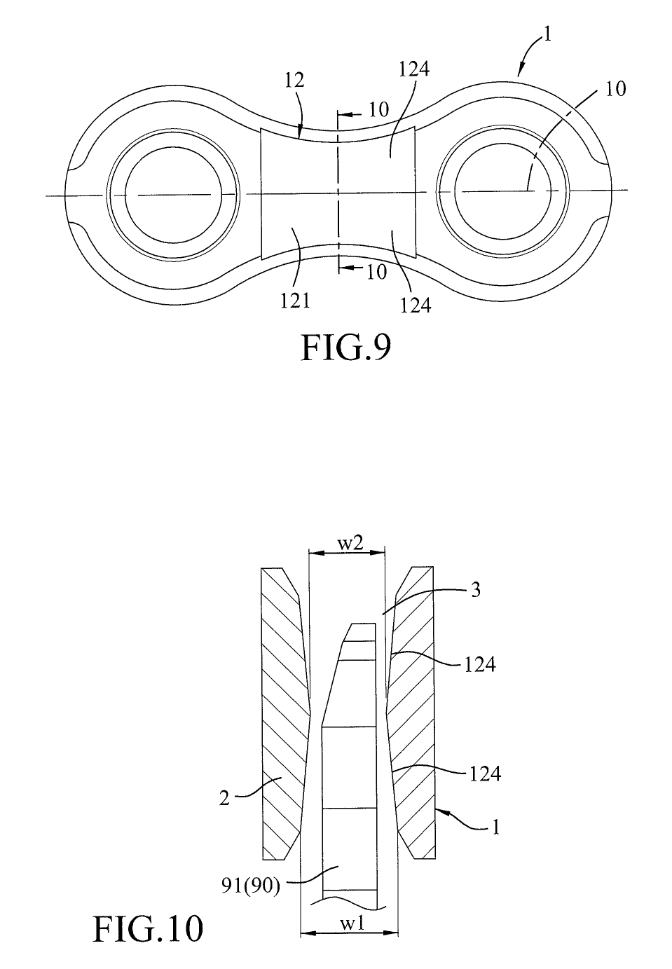

Referring to FIGS. 9 and 10, the third embodiment of the chain according to the disclosure is similar to the first embodiment. The connecting section 12 of the inner chain plate 1 further has two inclined inner surfaces 124 that are respectively located at the opposite sides of the central line 10 and that cooperatively define the first recess 121. Each of the inclined inner surfaces 124 is inclined away from the accompanying chain plate 2 in the direction away from the central line 10. The accompanying chain plate 2 is structurally identical to the inner chain plate 1. By such, the width (w1, see FIG. 10) of the opening of the engaging space 3 is relatively large so as to facilitate entrance of a corresponding one of the teeth 91 of the sprockets 90 into the engaging space 3 during the movement of the chain from one of the sprockets 90 to another. Moreover, the width (w2, see FIG. 10) of a middle portion of the engaging space 3 is relatively small, so the engagement between the engaging space 3 and the corresponding one of the teeth 91 is steady.

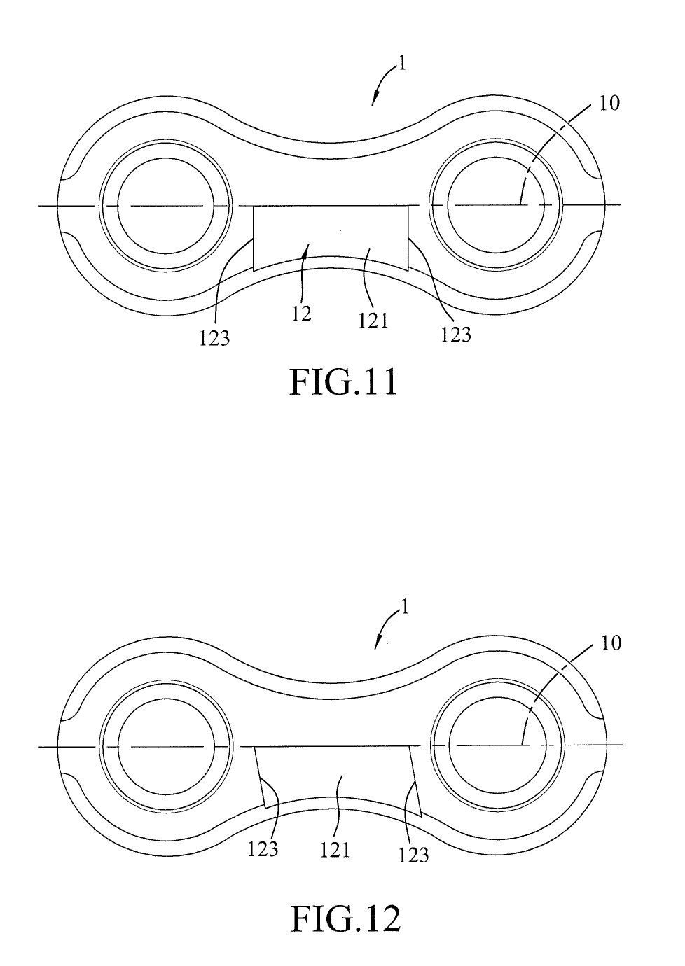

Referring to FIG. 11, the fourth embodiment of the chain according to the disclosure is different from the first embodiment in the first recess 121 of the inner chain plate 1. The first recess 121 of the fourth embodiment is formed at only one side of the central line 10, and the first edges 123 of the first recess 121 are perpendicular to the central line 10. The accompanying chain plate (not shown in FIG. 11) is structurally identical to the inner chain plate 1.

Referring to FIG. 12, the fifth embodiment of the chain according to the disclosure is similar to the fourth embodiment. The first recess 121 of the fifth embodiment is also formed at only one side of the central line 10, but the first edges 123 of the first recess 121 are oblique to the central line 10. The accompanying chain plate (not shown in FIG. 12) is structurally identical to the inner chain plate 1, and the first edges 123 of the first recess 121 and the second edges of the second recess (not shown in FIG. 12) extend in the same direction. The first recess 121 of each of the fourth and fifth embodiments also serves to increase the width of the opening of the engaging space 3 (with reference to FIGS. 1 and 5).

In summary, the first recess 121 of the inner chain plate 1 and the second recess 21 of the accompanying chain plate 2 serve to increase the width of the opening of the engaging space 3, so the chain of this disclosure is suitable for a sprocket assembly that consists of a relatively large number of sprockets. Moreover, since the first edges 123 of the first recess 121 of the inner chain plate 1 are parallel to each other, the inner chain plate 1 can be easily separated from a forming die in the forming process thereof.

In the description above, for the purposes of explanation, numerous specific details have been set forth in order to provide a thorough understanding of the embodiments. It will be apparent, however, to one skilled in the art, that one or more other embodiments may be practiced without some of these specific details. It should also be appreciated that reference throughout this specification to “one embodiment,” “an embodiment,” an embodiment with an indication of an ordinal number and so forth means that a particular feature, structure, or characteristic may be included in the practice of the disclosure. It should be further appreciated that in the description, various features are sometimes grouped together in a single embodiment, figure, or description thereof for the purpose of streamlining the disclosure and aiding in the understanding of various inventive aspects.

While the disclosure has been described in connection with what are considered the exemplary embodiments, it is understood that this disclosure is not limited to the disclosed embodiments but is intended to cover various arrangements included within the spirit and scope of the broadest interpretation so as to encompass all such modifications and equivalent arrangements.

What is claimed is:

1. A chain comprising at least one inner link unit, said at least one inner link unit including an inner chain plate, an accompanying chain plate that is spaced apart from said inner chain plate, and an engaging space that is defined between said inner chain plate and said accompanying chain plate, said inner chain plate having two end sections that are spaced apart from each other along a central line, and a connecting section that interconnects said end sections and that has a first recess recessed away from said accompanying chain plate, each of said end sections having a rod hole, said first recess having two first edges that are parallel to each other, said accompanying chain plate of said at least one inner link unit having a second recess that is recessed away from said inner chain plate, said second recess having two second edges that are parallel to each other and that are spaced apart from each other, said first edges of said first recess and said second edges of said second recess extending in the same direction.

2. The chain as claimed in claim 1, wherein said first edges of said inner chain plate and said second edges of said accompanying chain plate are perpendicular to the central line.

3. The chain as claimed in claim 1, wherein said first edges of said inner chain plate and said second edges of said accompanying chain plate are oblique to said central line.

4. The chain as claimed in claim 1, wherein said first edges of said inner chain plate of said at least one inner link unit extend across the central line.

5. The chain as claimed in claim 1, wherein said inner chain plate of said at least one inner link unit further has two inclined inner surfaces that are respectively located at two opposite sides of the central line and that cooperatively define said first recess, each of said inclined inner surfaces being inclined away from said accompanying chain plate in a direction away from the central line.

6. The chain as claimed in claim 1, wherein each of said end sections of said inner chain plate of said at least one inner link unit has an outer annular surface that faces away from said accompanying chain plate, said connecting section of said inner chain plate further having an outer connecting surface that is connected to said outer annular surfaces of said end sections and that is flush with said outer annular surfaces.

7. The chain as claimed in claim 1, wherein each of said end sections of said inner chain plate of said at least one inner link unit has an outer annular surface that faces away from said accompanying chain plate, said connecting section of said inner chain plate further having an outer connecting surface that is connected to said outer annular surfaces of said end sections, said outer connecting surface of said connecting section being not flush with said outer annular surfaces of said end sections, and being farther from said accompanying chain plate than said outer annular surfaces.

8. The chain as claimed in claim 1, wherein said inner chain plate of said at least one inner link unit further has a guide section that surrounds said end sections and said connecting section, said guide section having at least one inclined guide surface that extends along a periphery of said inner chain plate and over said connecting section, and that is inclined away from said accompanying chain plate in a direction away from the central line.

9. The chain as claimed in claim 8, wherein each of said end sections of said inner chain plate of said at least one inner link unit further has a protrusion that protrudes toward said accompanying chain plate, said rod hole of each of said end sections being formed through said protrusion of said corresponding end section.

10. The chain as claimed in claim 1 adapted to be used with a sprocket assembly, the sprocket assembly including twelve coaxially-arranged sprockets each of which has a plurality of teeth, said chain comprising a plurality of said inner link units, said chain further comprising:
a plurality of outer link units each including two spaced-apart outer chain plates; and
a plurality of connecting rods each of which has a central axis, and interconnects one of said inner link units and a corresponding one of said outer link units, the central axes of two adjacent ones of said connecting rods being spaced apart from each other by a link distance, the link distance corresponding to the chordal pitch of each of the sprockets, a ratio of the link distance to a width of said outer link units being 2.39±0.12.

11. The chain as claimed in claim 10, wherein, for each of said inner link units, each of said end sections of said inner chain plate has an outer annular surface that faces away from said accompanying chain plate, said connecting section of said inner chain plate further having an outer connecting surface that is connected to said outer annular surfaces of said end sections and that is flush with said outer annular surfaces.

12. The chain as claimed in claim 10, wherein, for each of said inner link units, each of said end sections of said inner chain plate has an outer annular surface that faces away from said accompanying chain plate, said connecting section of said inner chain plate further having an outer connecting surface that is connected to said outer annular surfaces of said end sections, said outer connecting surface of said connecting section being not flush with said outer annular surfaces of said end sections, and being farther from said accompanying chain plate than said outer annular surfaces, a ratio of the link distance to a maximum width of said inner link unit being 2.39±0.12.

13. The chain as claimed in claim 10, wherein a ratio of the link distance to a maximum width of said engaging space defined between said inner chain plate and said accompanying chain plate of each of said inner link units is 5.5±0.12.
